(19) United States
(12) Patent Application Publication
(10) Pub. No.: US 2013/0297352 A1
(43) Pub. Date: Nov. 7, 2013

(54) MOBILE APPLICATION FOR AUTOMOBILE SERVICES

(71) Applicants: Tom Noe, Snohomish, WA (US); Jeffrey M. Ward, Sammamish, WA (US)

(72) Inventors: Tom Noe, Snohomish, WA (US); Jeffrey M. Ward, Sammamish, WA (US)

(21) Appl. No.: 13/769,621

(22) Filed: Feb. 18, 2013

Related U.S. Application Data
(60) Provisional application No. 61/600,549, filed on Feb. 17, 2012.

(51) Int. Cl. G06Q 10/02; G06Q 40/08

(52) U.S. Cl. CPC G06Q 10/02; G06Q 40/08
USPC 705/4; 705/5

(57) ABSTRACT

An application for mobile devices presents a number of user interface screens that include information received from a server computer. The user interface screens include icons or controls that allow a user to interact with a sales or service department of a selected dealer, schedule service appointments, edit, store and recall warranty and insurance information. In addition, a user interface screen allows the user to capture information regarding an accident and to forward the information to a user's insurance carrier.

### RELATED APPLICATIONS

The present application claims the benefit of, and priority to, U.S. Provisional Patent Application No. 61/600,549 filed Feb. 17, 2012, which is herein incorporated by reference in its entirety.

### TECHNICAL FIELD

The disclosed technology relates generally to software applications, and in particular to software applications for mobile devices that support automobile sales and service providers as well as drivers.

### BACKGROUND

Automobile dealerships spend a great deal of advertising money designed to attract customers into their showrooms. However, once an automobile sale has been made, the retention rate of the customer to the dealer's service department is often very low. As a result, many dealerships engage in additional advertising such as direct mail or electronic coupons in order to try and keep contact with their customers. The provision of such services both generates revenue for the dealership and increases the likelihood that the customers will become repeat buyers.

Despite the best efforts of dealerships, direct mail and electronic coupons are not cost effective ways of retaining customers. Coupons for service discounts and the like tend to get lost and customers often do not remember when their car is due for service. As a result, many customers take the path of least resistance when their car needs service and will have their car serviced at whatever dealer or service station is most convenient at any given time.

As a result, there is a need for technology with which dealers and/or service stations can maintain useful relationships with their customers while providing customers useful tools to manage their automotive needs.

### BRIEF DESCRIPTION OF THE DRAWINGS

FIG. 1 is a block diagram of a computer system for implementing a mobile automobile application in accordance with one embodiment of the disclosed technology;

FIG. 1A is a flow diagram of steps performed by a server computer in accordance with one embodiment of the disclosed technology in order to analyze service information to create service schedules for various makes and models of automobiles;

FIG. 2 is a representative user interface login screen in accordance with an embodiment of the disclosed technology;

FIG. 3 illustrates a representative user interface screen in which a user can select between one or more automobile dealerships or service stations;

FIG. 4 illustrates a representative user interface screen in which a user can interact with an automobile dealership's sales or service department as well as performing other tasks in accordance with an embodiment of the disclosed technology;

FIG. 5 illustrates a representative user interface screen in which a user can interact with an automobile dealership's sales department in accordance with an embodiment of the disclosed technology;

FIG. 6 illustrates a representative user interface screen in which a user can interact with an automobile dealership's service department as well as performing other tasks in accordance with an embodiment of the disclosed technology;

FIG. 7 illustrates a representative user interface screen in which a user can schedule a service appointment in accordance with an embodiment of the disclosed technology;

FIG. 8 illustrates a representative user interface screen in which a user can interact with another automobile dealership's sales or service department in accordance with an embodiment of the disclosed technology;

FIG. 9 illustrates a representative user interface screen in which a user can interact with the sales department of the other automobile dealership in accordance with an embodiment of the disclosed technology;

FIG. 10 illustrates a user interface screen defining a carport in which a user can associate vehicles with a particular automobile dealership or service department in accordance with an embodiment of the disclosed technology;

FIG. 11 illustrates a representative user interface screen in which a user can enter, edit or recall data for a particular vehicle as well as performing other functions in accordance with an embodiment of the disclosed technology;

FIG. 12 illustrates a representative user interface screen in which a user can enter, edit or recall information in a glove box in accordance with an embodiment of the disclosed technology;

FIG. 13 illustrates a representative user interface screen in which a user can enter, edit or recall information about insurance carried in accordance with an embodiment of the disclosed technology;

FIG. 14 illustrates a representative user interface screen in which a user can enter, edit or recall information about roadside assistance for one or more vehicles in accordance with an embodiment of the disclosed technology;

FIG. 15 illustrates a representative user interface screen in which a user can enter, edit or recall information about an extended warranty maintained on a vehicle in accordance with an embodiment of the disclosed technology; and

FIG. 16 illustrates a user interface screen in which a user can enter information and perform other functions in the event of an accident in accordance with an embodiment of the disclosed technology.

### DETAILED DESCRIPTION

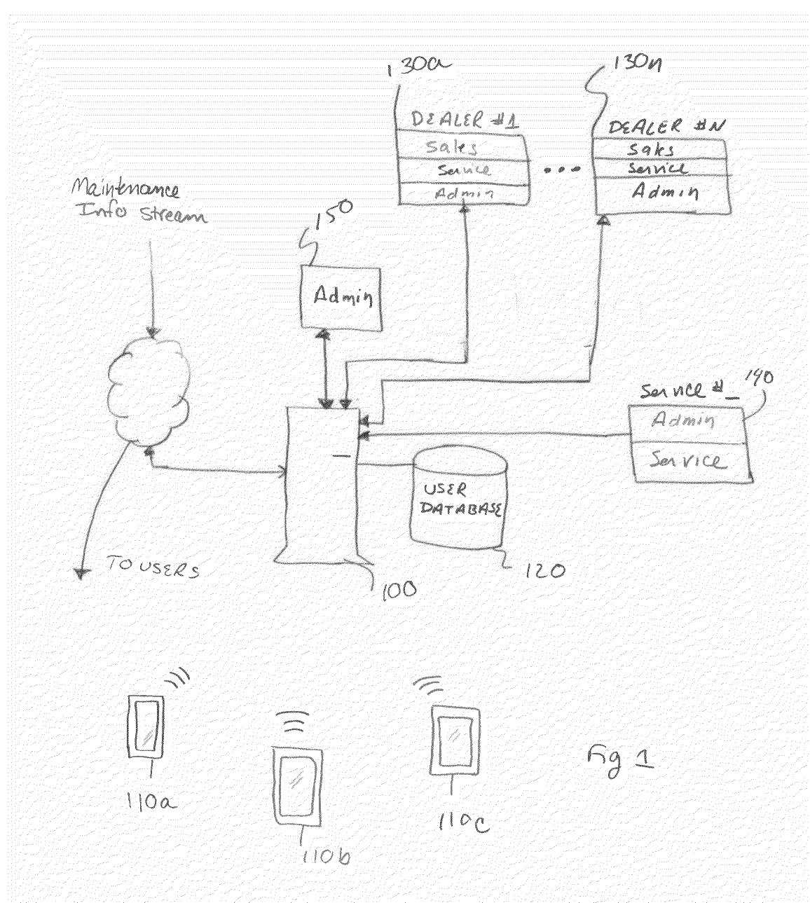

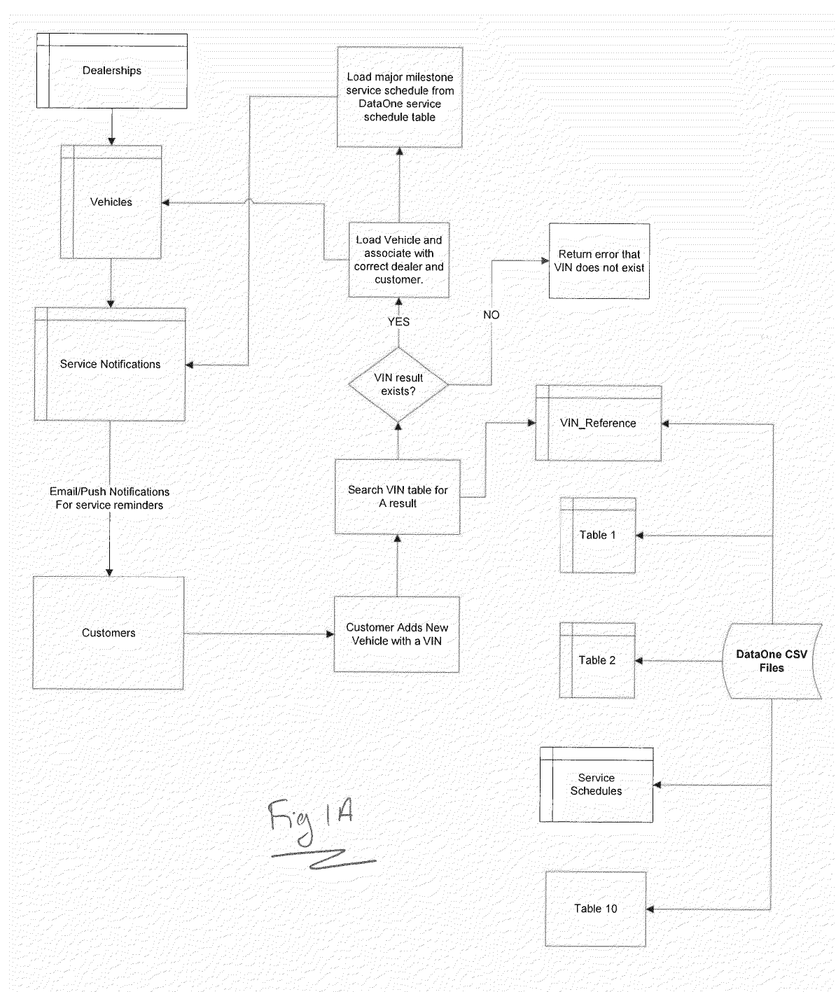

FIG. 1 illustrates a representative computer system for operating a mobile automotive application in accordance with the disclosed technology. One or more server computers 100 include one or more programmed processors that execute instructions to send and receive information to a number of mobile devices 110a, 110b, 110c, etc. as will be described in further detail below. Preferably each mobile device 110 is a smart phone, or other portable computing device capable of running one or more applications (e.g. an “app”). Suitable smart phones include Apple iPhones, or other comparable phones from HTC, LG, Motorola, Samsung, Sanyo, Blackberry or other manufacturers. Alternatively, the mobile devices 110 may be portable computers, personal digital assistants, slate computers (e.g. Apple iPad) or other devices which have the ability to send and receive information to the server computer 100 via a cellular, wired or wireless (e.g. WiFi, WiMax etc.) communication link. The details of the mobile devices are considered well known to those of ordinary skill in the art of mobile application development and need not be discussed in further detail.

As is common with software apps, a user downloads the app from an app store, e.g. Apple iTunes (not shown). The store loads a sequence of program instructions and other files onto the mobile device directly or onto another computer that in turn loads the app onto the mobile device. When the app is run, a programmed processor within the mobile device 110 executes the instructions to present a number of user interface (UI) screens to the user in which information can be entered, displayed and passed back and forth between the mobile device 110 and the server computers 100 via a computer communication link.

In one embodiment, the server computer 100 maintains a user database 120 that stored records for a number of registered users and their vehicles. In one embodiment of the system each user is identified by a unique identifier such as their e-mail address and their vehicles are identified by their vehicle identification numbers (VIN), which are unique to each vehicle manufactured. The server computer system 100 also interacts with a number of automobile dealerships 130a-130n. Each of these dealerships may have a separate sales department and service department. In addition, an administrator from each of the dealerships can also interact with the server computer 100 to change the contact information or graphics images displayed for their dealership and perform other functions as will be described in further detail below. In some embodiments, the dealerships 130a-130n may not have both sales and service departments. Some dealerships may only have sales departments but not service departments. In addition, the server computer 100 can interact with a number of independent service stations 140 (e.g. Jiffy Lube, Grease Monkey, independent repair shops etc.) in order to allow customers to receive information and schedule service appointments with these service stations as desired as will be described in further detail below. Overall control of the server computer 100 is performed by an administrator 150 that can add or remove dealerships or service stations, perform system maintenance and the like.

In one embodiment, the server computer 100 receives vehicle maintenance information from a third party provider (e.g. Dominion) that indicates service items to be performed on a variety of different types of vehicles. Such service items are typically defined by a year, make and model of a vehicle, as well as a recommended mileage at which the service should be performed. In addition, if any additional service information such as a recall notice is issued, the recall information is included in the maintenance information that is received by the server computer 100. The server computer 100 receives the maintenance information on a periodic basis (e.g. once a day, once a week, once a month etc.) and analyzes the information to build a schedule of the various service items to be performed for each given make and model of car and the mileage at which such service should be performed. For example, some automobiles may be scheduled to have an oil change every 5,000 miles while others are scheduled to have their oil changed every 7,500 miles. Therefore, the server computer system 100 builds and maintains a schedule of the various service items to be performed on each make and model of vehicle for each mileage interval.

As will be described in further detail below, the server computer system operates to push messages out to the registered users when their vehicle is due for service. In one embodiment, the server computer looks for groups of recommended service items associated with any particular make and model of vehicle and groups them by mileage so as to avoid sending too many messages to the registered users. For example, messages may only be sent out when a vehicle is due for an oil change or at every major service interval. Alternatively, messages may be sent out if a special vehicle recall notice is included in the maintenance information received.

The server computer system 100 also has the ability to push other types of messages to one or more of the registered users. Such messages can include sales or service specials or notifications of software upgrades or the like. Such messages can be requested by the dealerships 130 or independent service stations or may be from the administrator of the app.

In one embodiment, a user registers their vehicle when they purchase an automobile from a dealership. A salesman at the dealer gathers the customers contact information such an e-mail address and VIN number for the car and enters the information into a web form produced by the server computer 100. Information entered into the web form is stored in the database 120. If the vehicle purchased is used, then the actual mileage is stored as well along with an estimate of how many miles the customer drives per year in order to determine when the vehicle may need service. If no average yearly mileage is entered, an amount such as 15,000 miles/year can be assumed.

FIG. 1A is a representative flow diagram of steps performed by the server computer 100 to analyze the maintenance information received in order to create service schedules for various makes and models of automobiles. The maintenance information is typically received over a computer communication link (e.g. the Internet) in a conventional file format such as a comma separated value (CSV) format. The maintenance information generally includes a VIN identifier that identifies a make and model of automobile as wall as a description of the service and mileage at which the service is to be performed. The server breaks the maintenance information into major service items that are stored in tables (or other logical format) by make and model of automobile. If a user enters their own VIN number, the server checks to see if the number is valid and if so, associates the vehicle with a dealer code provided by the user. If the VIN number is correct, then the server compares the miles on the vehicle to the maintenance schedule for the vehicle to determine if any maintenance is due to be performed. If the vehicle is not yet due, the server computer estimates when the vehicle will hit the mileage when service is due and sends the user a reminder at that time. The estimates of when the vehicle will hit the service mileage can be based on either reported mileage or by extrapolating the current mileage and the estimated number of miles driven per year.

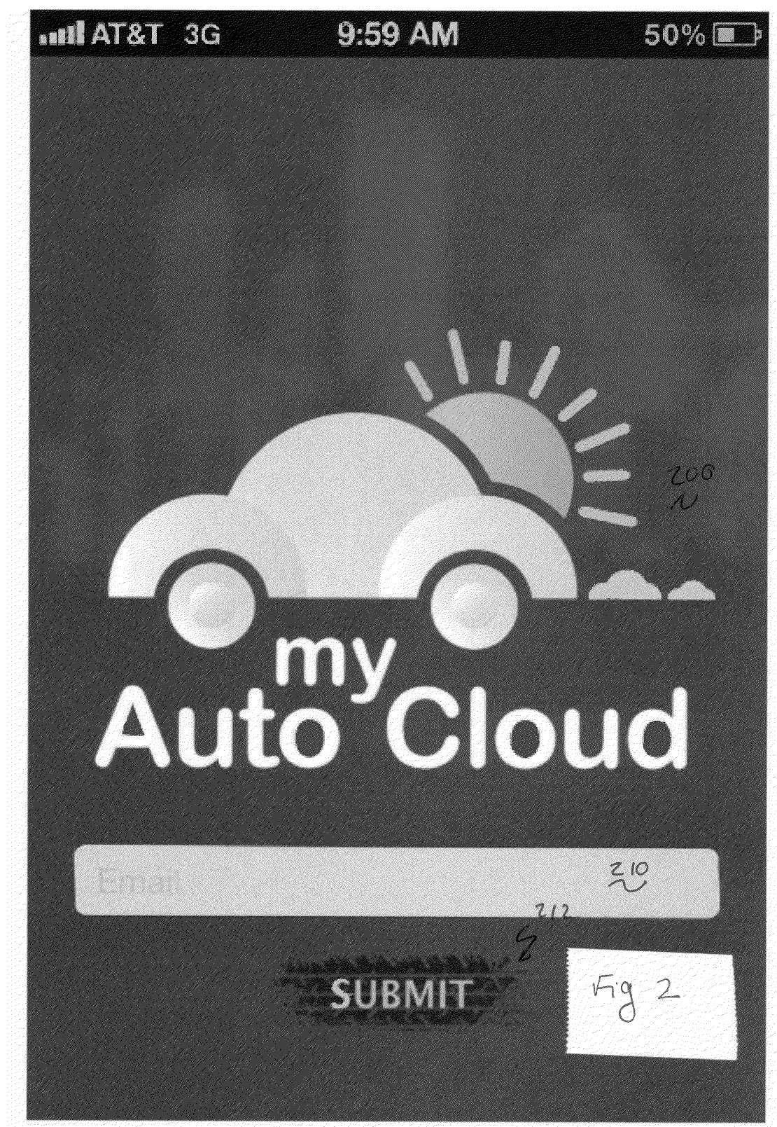

FIG. 2 illustrates a representative user interface (UI) screen encountered when a user first launches the mobile automotive app on their mobile device. The user interface screen 200 includes a text window 210 in which the user can enter their information (e.g., e-mail address or other information). In one embodiment, all users are uniquely identified by their e-mail address in the system. However, it will be appreciated that other identifiers, such as their cellular telephone number, could be used if desired. A control 212 causes the app to send the e-mail address entered in the text window 210 to the server computer 100 shown in FIG. 1 in order to activate the user's account. In one embodiment, the user interface screen includes a control bar at the bottom of the screen that shows a number of icons that allow a user to quickly navigate to other functions provided by the app. These functions can include contacting the sales associate for a dealer, scheduling a service appointment, editing or viewing information in a carport or glove box that is stored on the mobile device. Each of these functions is described in further detail below.

Typically a user registers with the system at the automobile dealer when they either purchase an automobile or when they have service performed. If the user's e-mail address is not found on the system, then the user can self register with the system. In this case, a user registration UI screen (not shown) is presented by the app in which a user can enter such information as their name, contact information, e-mail address, VIN numbers of cars they want to register, mileage on the vehicles, an estimate of the miles driven each year as well as a dealer code. If the user does not know their dealer code, a text window can be provided where the user can enter all or a portion of the dealer's name in order to search a dealer database on the server computer 100 to find the correct code. As will be discussed in detail below, communications from the user's app to the server computer generally include the user's identifier, a VIN number or portion thereof and the dealer code so that the server can determine which dealer (including sales associate or team) the user would like to interact with. In some embodiments, the user can download an application from a website (e.g., a dealership website, manufacture website, sales representative website, or other appropriate website) and install the application. The application can include instructions or prompts for inputting user information.

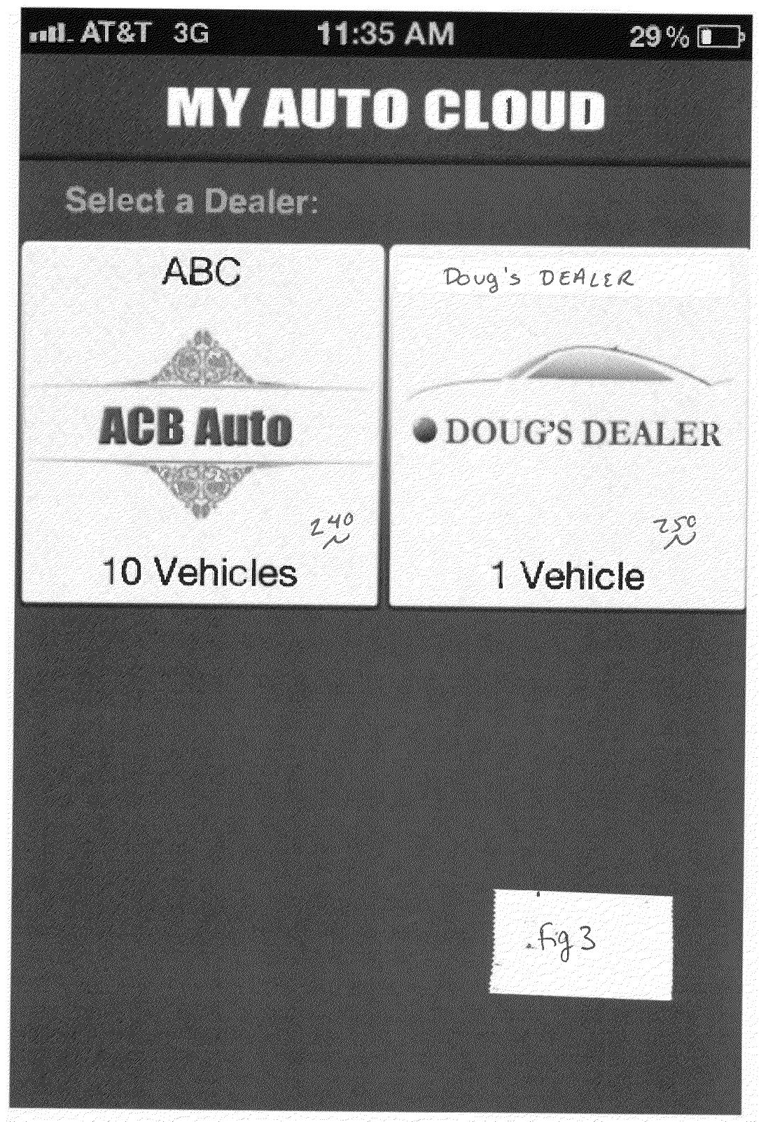

FIG. 3 shows a representative UI screen including a number of icons 240, 250 each of which is associated with a different automotive dealership or repair facility (collectively referred to herein as a “dealer”). Each icon preferably includes the name of the dealer, a logo of the dealer and an indication of how many vehicles the user has associated with that particular dealer. In the example shown, a user has associated 10 vehicles with the dealer “ABC” and one vehicle associated with “Doug's Dealer”. Selection of either of the icons 240 or 250 causes the app program to present user interface screens associated with the selected dealer.

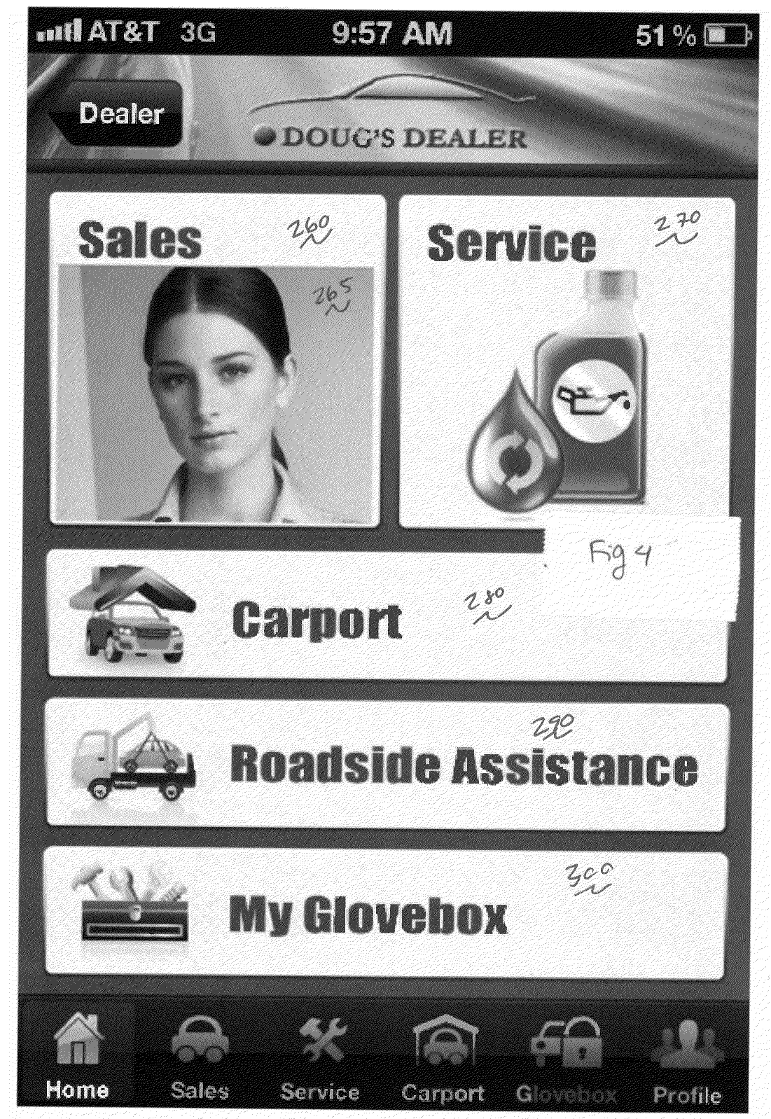

FIG. 4 illustrates a representative user interface screen associated with Doug's Dealer presented by the mobile device when the user selects the icon 250 shown in FIG. 3. The user interface screen includes an icon 260 associated with the sales department of the selected dealer and an icon 270 associated with the service department of the selected dealer. In one embodiment, the icons 260 and 270 include photographs of a sales person or service representative associated with the particular registered user. In the example shown, a photograph 265 shows the sales person from whom the user of the app user has purchased a car at the selected dealer. In the event that the sales person leaves the dealership, an administrator from the dealer can replace the photograph 265 with a photograph of a new sales person and a message can be sent to the user who is associated with the former sales person that informs the user that a transition in the sales team has occurred. In this way, the user feels a connection to a particular sales person at the selected dealer. If no particular sales or service person is assigned to a user, the icons 260 and 270 can contain a generic graphic image of a sales or service department such as is shown in icon 270.

Also included in the representative user interface screen is an icon 280 representing a “carport” in which the user can enter, edit or recall information about particular cars they own. An icon 290 allows a user to enter, edit or recall information for roadside assistance associated with their particular automobiles. The roadside assistance information may include telephone numbers for roadside assistance associated with particular manufacturers. Alternatively or in addition, the roadside assistance icon may allow a user to store additional information for third party roadside assistance services such as AAA, etc.

An icon 300 represents the user's “glove box” in which information is stored on the mobile device 110. Selecting the icon 300 allows a user to enter, edit and recall information for different warranties, insurance information or other information associated with the user's vehicles. In addition, the user can record and send information associated with an accident that will be described in further detail below.

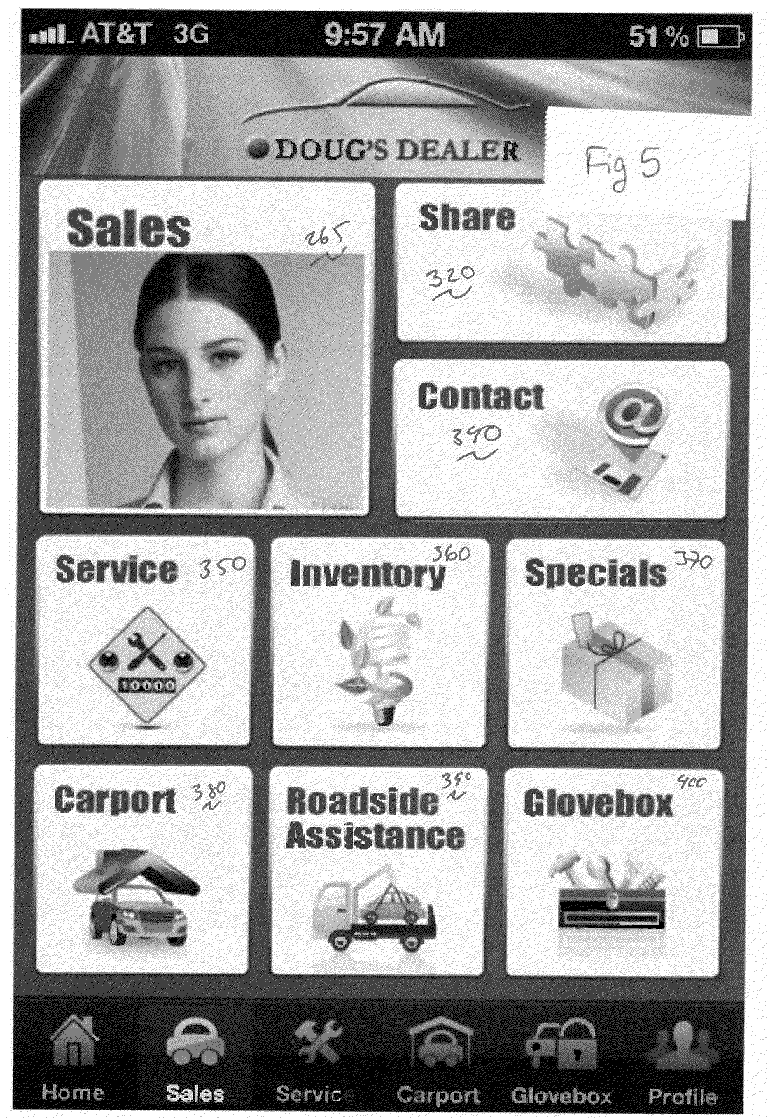

FIG. 5 illustrates a representative user interface screen presented by the mobile device that is associated with a sales department of an automotive dealer. As indicated above, the user interface screen includes a photograph 265 of a sales person associated with the particular registered user. An icon 320 allows a user to post a comment about the sales person or the dealership on a social network site such as Facebook or by sending e-mails to selected individuals. Selection of the icon 320 produces a pop-up window (not shown) that asks the user whether they want to use e-mail or post a comment on a social network site. Depending upon the selection made, a generic message is posted on the user's wall if using Facebook or the user's mail program on the mobile device is activated and pre-populated with a generic message that recommends the sales person shown in the photograph 265. If the message is sent, the server computer notifies the sales person via e-mail or other messaging protocol so that they can follow up with the recipient of the message.

An icon 340 activates the e-mail program on the user's mobile device to allow the registered user to send a message via e-mail to their designated sales person at the dealer via their e-mail program.

Also included on the user interface screen are a series of icons 350, 360 and 370. The icon 350 allows a user to set up a service appointment with the dealership's service department. An icon 360 activates a web browser program on the mobile device with a link to the current inventory of vehicles maintained by the selected dealer. An icon 370 directs the browser program on a user's mobile device to a web page listing any specials currently offered by the dealer.

The user interface screen also includes icons 380, 390 and 400. Icon 380 allows the user to enter, edit and recall information about cars in the carport. The icon 390 allows a user to enter, edit or recall information stored regarding roadside assistance for one or more of their vehicles. The icon 400 allows the user to enter, edit or recall information stored in the glove box.

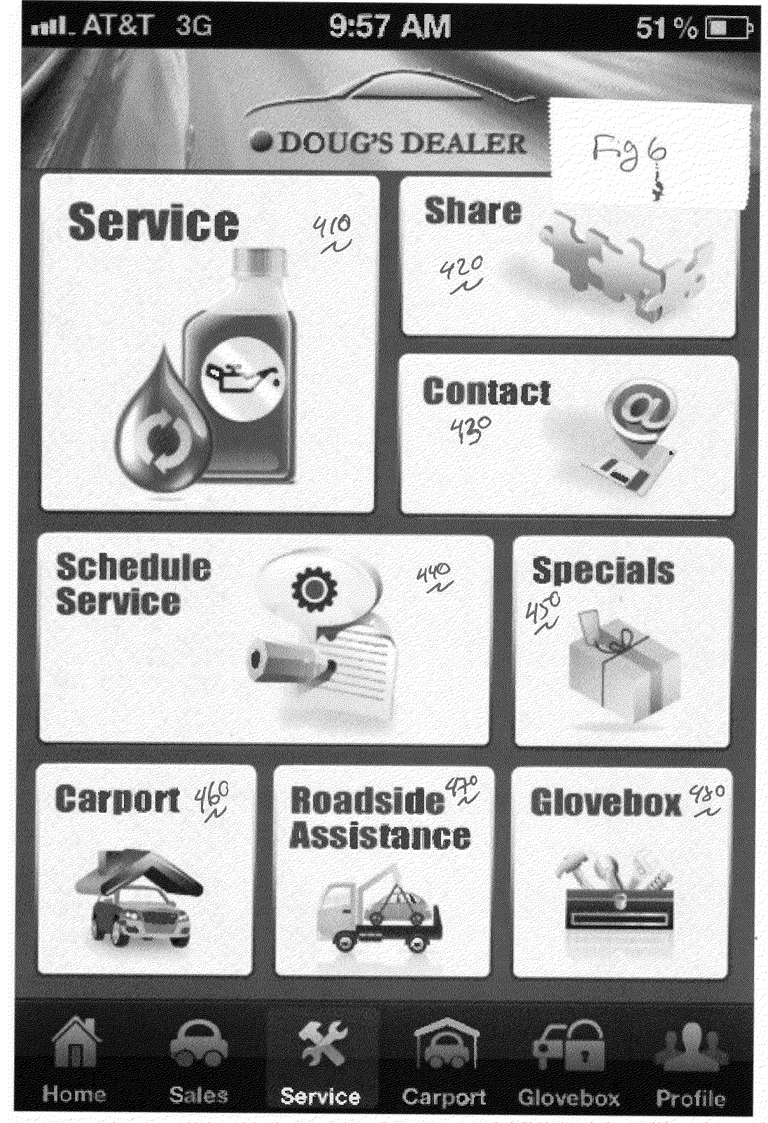

FIG. 6 illustrates a representative user interface screen associated with the service department for a selected dealer. As indicated above, the user interface screen includes an image 410 which may be a generic graphic representing service for an automobile or it may be a photograph of a service person assigned or associated with the registered user. An icon 420 allows a user to post a message regarding the designated service person to a social media site or via e-mail in the same manner that the user can post message about a sales person as described above. An icon 430 causes the e-mail program on the user's mobile device to launch and allows a user to send an e-mail to the dealer's service department. An icon 440 allows the user to request a service appointment as will be discussed in further detail below. An icon 450 launches the browser program on the user's mobile device and directs the browser program to a site showing any service specials currently offered by the selected dealer. An icon 460 allows the user to enter, edit or recall information about cars in their carport. An icon 470 allows the user to enter, edit or recall information regarding roadside assistance for any of their vehicles. An icon 480 allows a user to enter, edit or recall information stored in the glove box.

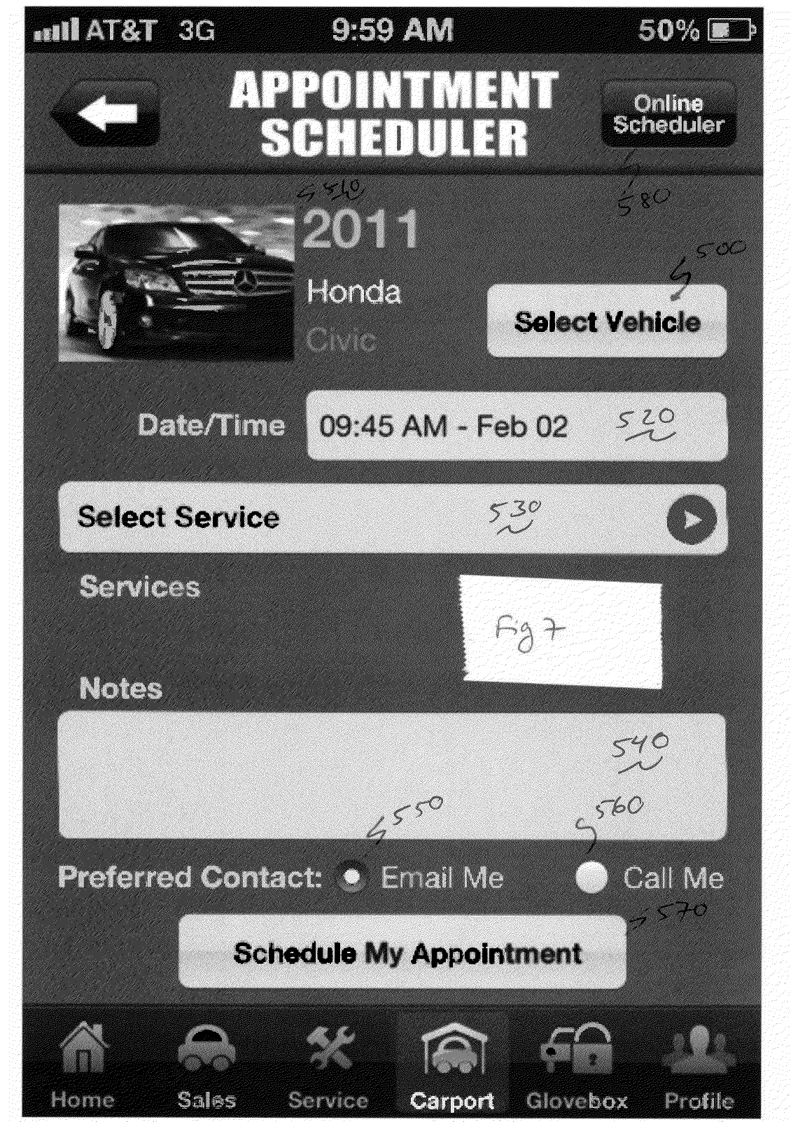

FIG. 7 illustrates a representative user interface screen presented by the mobile device when the user desires to schedule a service appointment with a selected dealer. The user interface screen includes a control 500 which when selected produces a list of vehicles currently owned by the user. Upon the selection of a particular vehicle in the list, the app presents a representative image of the vehicle 510 is displayed along with its model year, brand and manufacturer. A window 520 is provided in which the user can select a time and date for which they would like to schedule a service. In some embodiments, the user can enter any desired time and date. In other embodiments, the only times and dates that are available can be selected by the user. A window 530 produces a drop down list of desired services such as an oil change, 15,000, 30,000, 45,000-mile major services etc. The list of available services shown in the window 530 may be dependent upon the particular brand and model of the vehicle selected with the control 500. In that case, the application recalls different information to populate the drop down list depending upon the make and model of vehicle selected. A text window 540 is provided where the user can enter information to be viewed by the service department upon scheduling the service. A pair of radio buttons 550, 560 can be selected for the user to indicate their preferred method of contact regarding the service appointment such as via e-mail or via telephone. Such preferred method can be used to receive a message when the service is complete or if there are any scheduling problems or problems are detected when the service is being performed. A button 570 is provided to transmit all the information entered into the user interface screen shown in FIG. 7 to the server computer 100, which is then forwarded on to the service department of the selected dealer.

Also included in the user interface screen shown in FIG. 7 is a control 580 that causes a browser program on the user's mobile device to launch and navigate to the dealer's online appointment scheduler if the dealership has this capability. If the dealer does not have such an online scheduling program, then the control 580 does not appear on the user interface screen associated with that particular dealer.

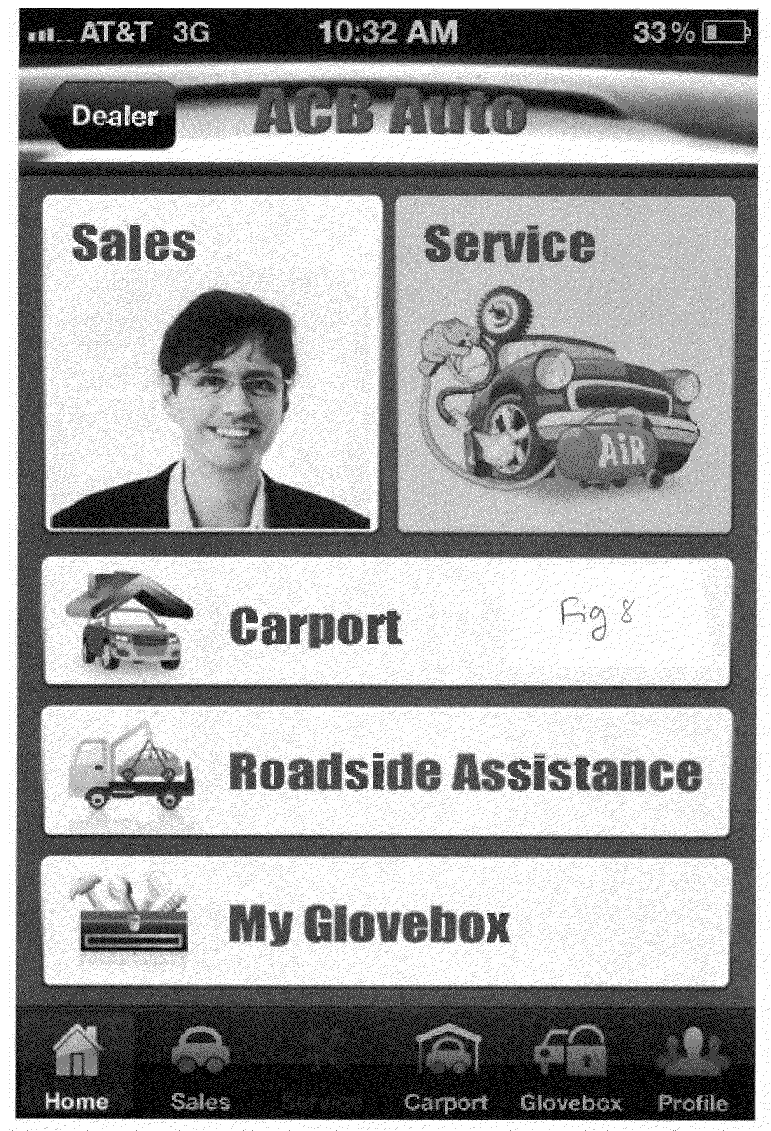

FIG. 8 illustrates a representative user interface screen that is similar to the one shown in FIG. 4 but is presented by the app if the user selects the other dealer icon 240 as shown in FIG. 4. As can be seen by comparing FIG. 8 and FIG. 4, many of the icons and controls are the same, but the image of the designated sales associate differs and the graphics shown for any particular dealership may also vary. However, functionality is generally the same.

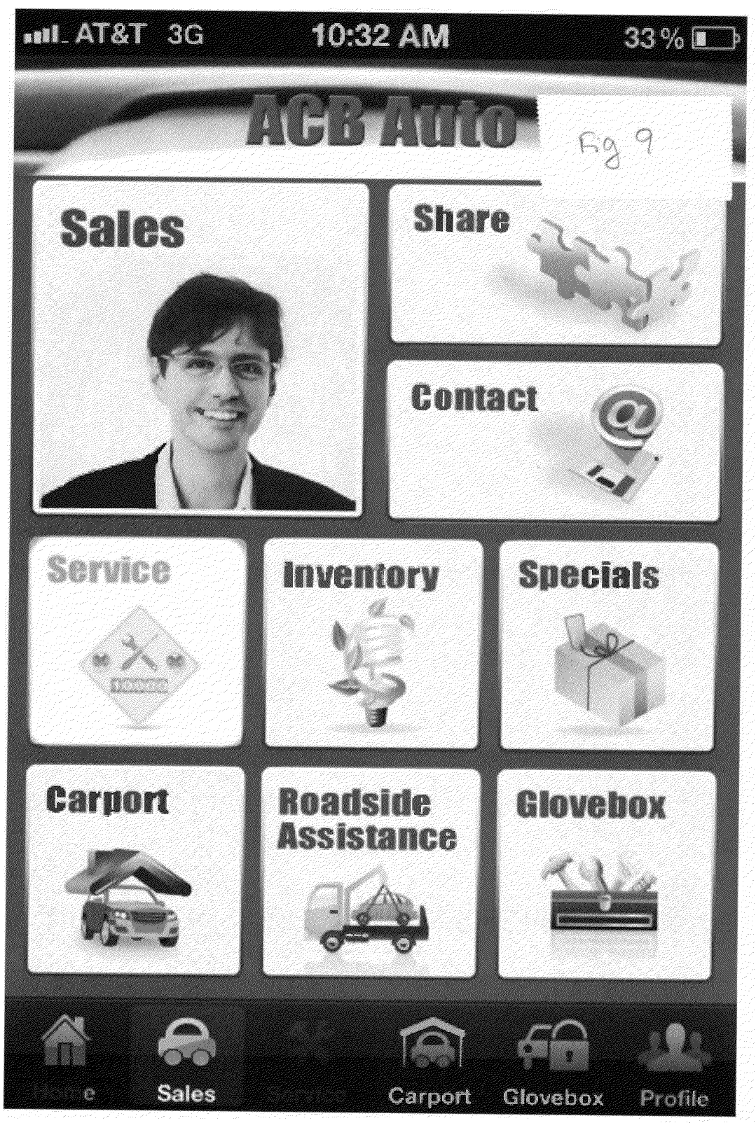

FIG. 9 illustrates a representative user interface including a series of icons associated with the sales side of the selected dealership. In the same manner as shown in FIG. 4, the user can use the icons on the screen to post comments regarding a sales associate or contact the sales associate. In addition, the user can schedule service, view inventory of the dealership, look for specials from the dealership, as well as enter, edit or recall information about their vehicles stored in the carport, information associated with roadside assistance or warranty insurance information maintained in the glove box.

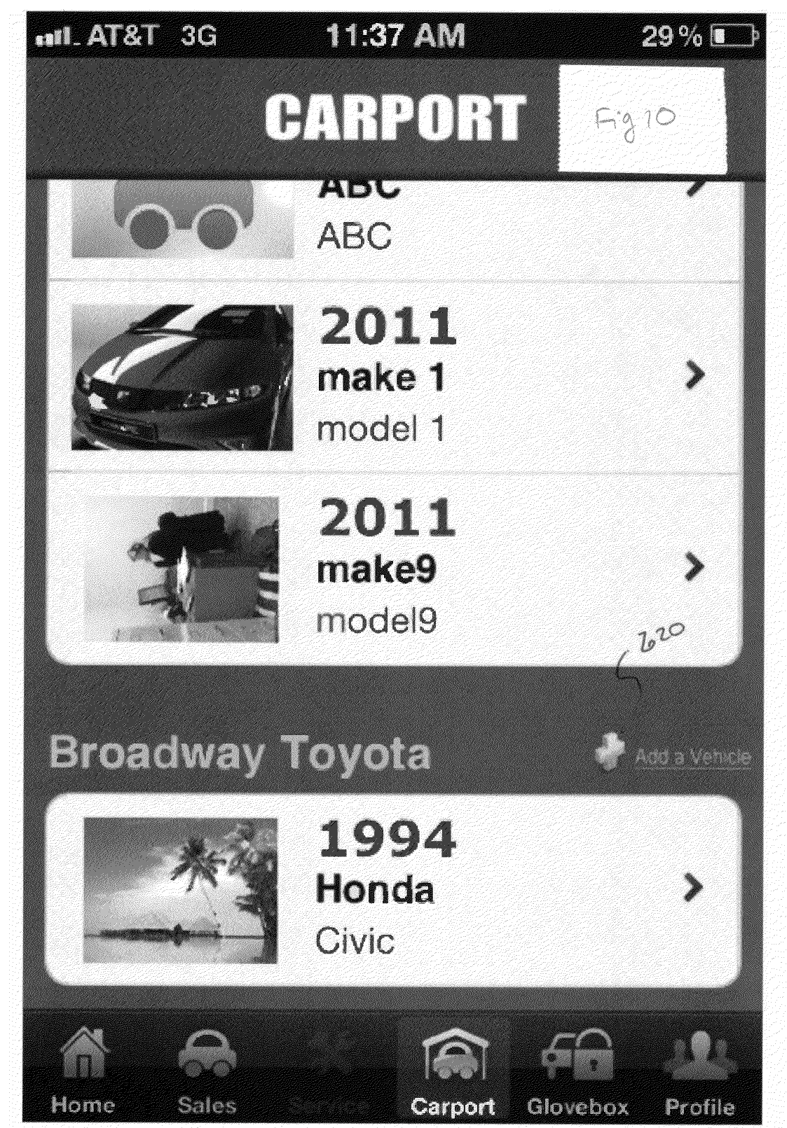

As indicated above, users can store information about particular vehicles associated with any given dealership in the carport on their mobile device. FIG. 10 illustrates a representative user interface screen presented by the application program upon selection of a carport icon either on the user interface screen or upon selection of the corresponding icon at a control bar at the bottom of the user interface screen. As indicated above, a user can store information regarding makes and models of cars purchased from or associated with a particular automobile dealer. In one embodiment, an automobile is added to the carport by the sales person when the user buys a car from the dealer. Alternatively a user may associate vehicles with any particular dealer on their own. In one embodiment the mobile device stores a dealer code that uniquely identifies a dealer for each automobile in order to associate a dealer and a particular VIN number.

If the user wishes to add another vehicle associated with any particular dealer, the user merely selects a control 620 that prompts the user to enter information for an additional vehicle and to associate it with a particular dealer.

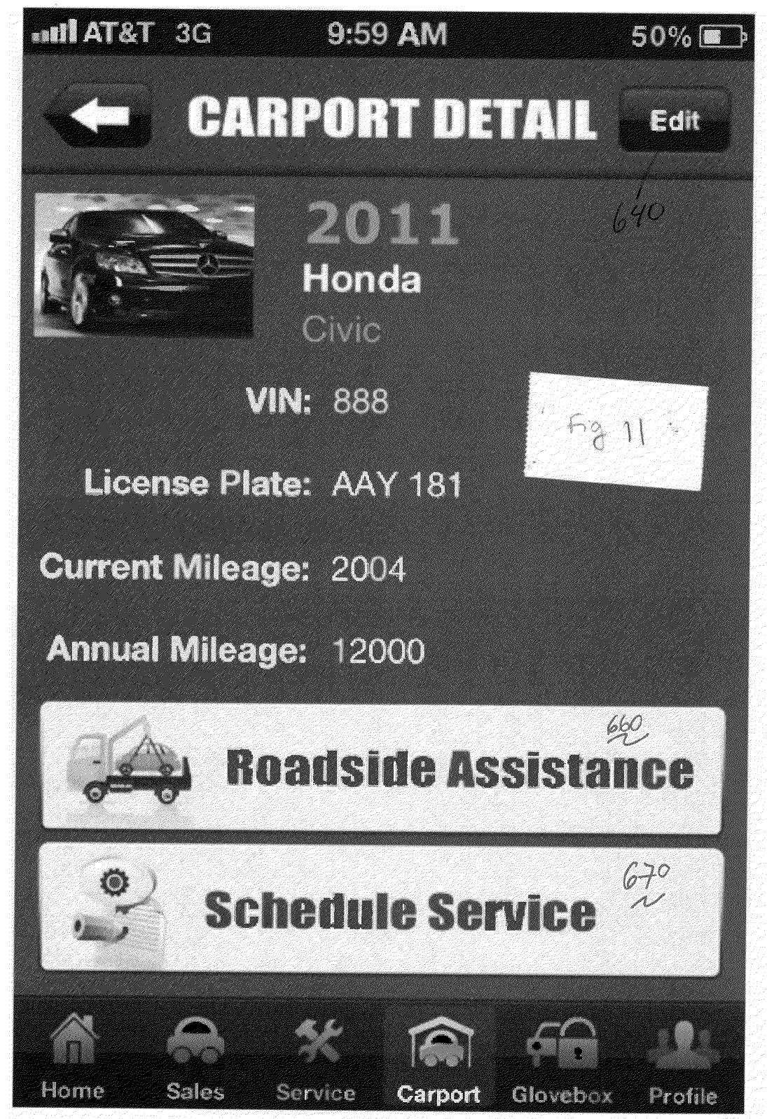

FIG. 11 illustrates a representative user interface screen in which a user can view information stored on the mobile device for any particular vehicle. The information displayed on the user interface screen includes the model year, manufacturer of the car and model name. In addition, all or a portion of the vehicle's VIN number is displayed along with its license plate code, its current mileage and the average number of miles expected to be driven in a year. A control 640 on the user interface screen is provided so that a user can edit any information about a particular vehicle. In addition, the user interface screen includes a control 660 that allows the user to enter, edit or recall information for roadside assistance associated with the vehicle. In some instances, the roadside assistance is provided by the manufacturer of the vehicle for a particular warranty period. In addition or alternatively, a user can enter information about third party roadside assistance providers such as AAA if they subscribe to such a service. A control 670 allows the user to request a service appointment for the automobile shown on the user interface screen. Selecting the control 670 brings up the user interface screen similar to the schedule service user interface screen as shown in FIG. 7.

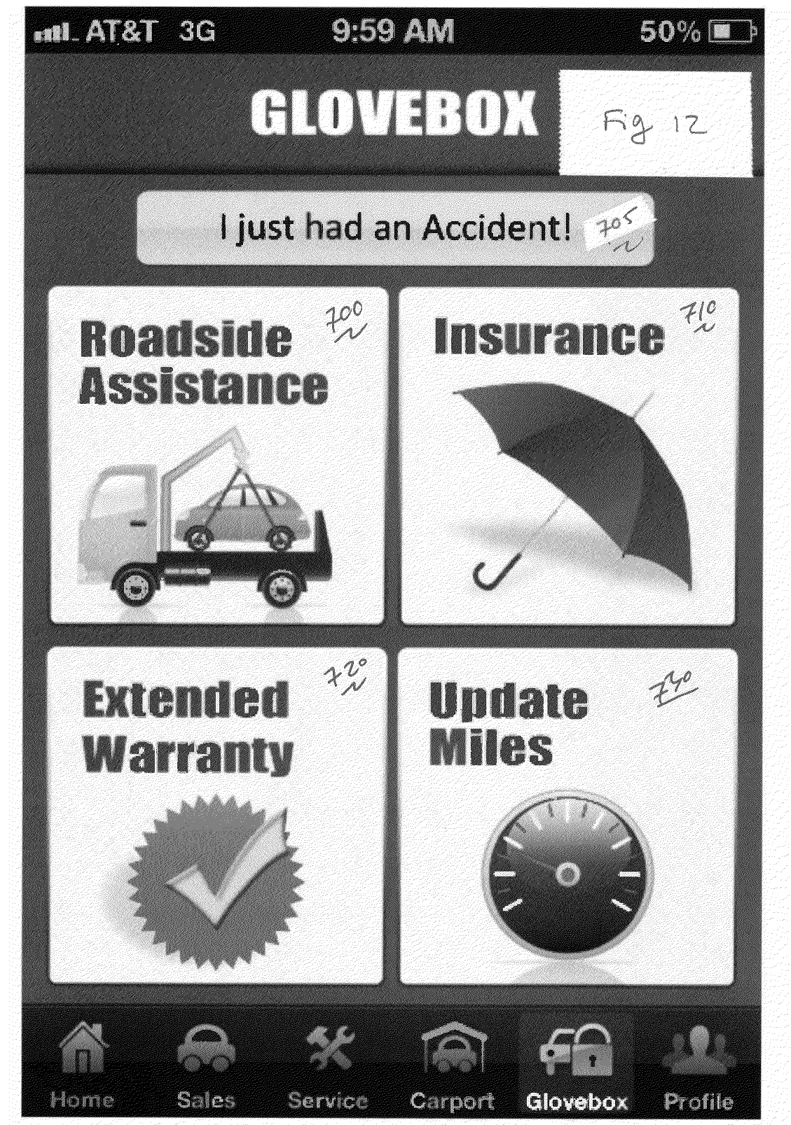

FIG. 12 shows a representative user interface screen associated with the glove box. The glove box stores information about the user's vehicles on the mobile device. In one embodiment, the user interface screen shown at FIG. 12 has a number of controls allowing a user to enter, edit or recall information associated with roadside assistance, insurance, extended warranty and miles on a vehicle. An icon 700 allows the user to enter, edit or recall information associated with roadside assistance for one or more vehicles. An icon 710 allows a user to enter, edit or recall information associated with insurance maintained on one or more of the vehicles. An icon 720 allows the user to enter, edit or recall information associated with an extended warranty maintained on one or more of the vehicles and an icon 730 allows a user to enter, edit or recall a number of miles currently recorded on the odometer of one or more of the vehicles. In addition, the user interface screen includes an icon 740 that can be selected by the user when they are involved in an accident.

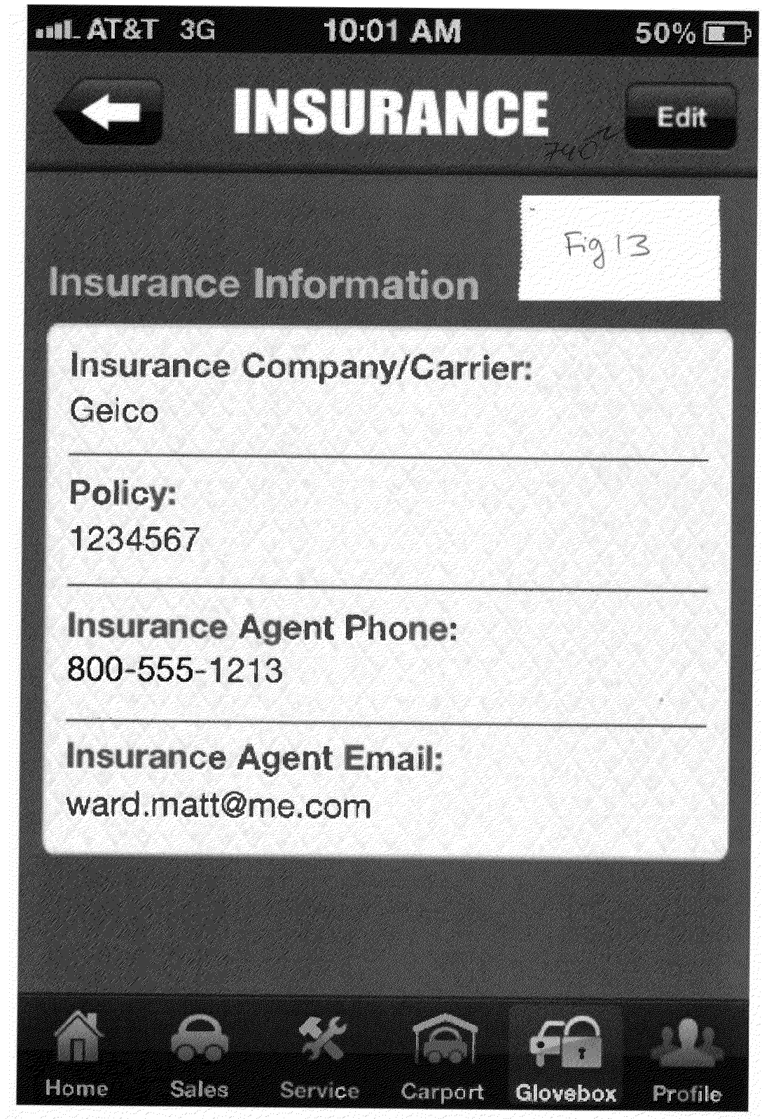

FIG. 13 shows a representative user interface screen presented by the app when the user selects the insurance icon 710 shown in FIG. 12. The user interface screen displays such information as the name of their insurance company, the policy number, the agent's telephone and e-mail address associated with the user's insurance agent.

Although not shown, the user interface screen may include a digital certificate that serves as proof of current insurance. This may relieve the user from having to carry cards sent from the insurance company as proof of current insurance. A control 740 on the user interface screen is provided so that the user can edit the information for their insurance policy. Using the app, the server 100 can receive the certificate from the insurance company that confirms the insurance is in force and the server 100 forwards it to the user for an associated VIN number.

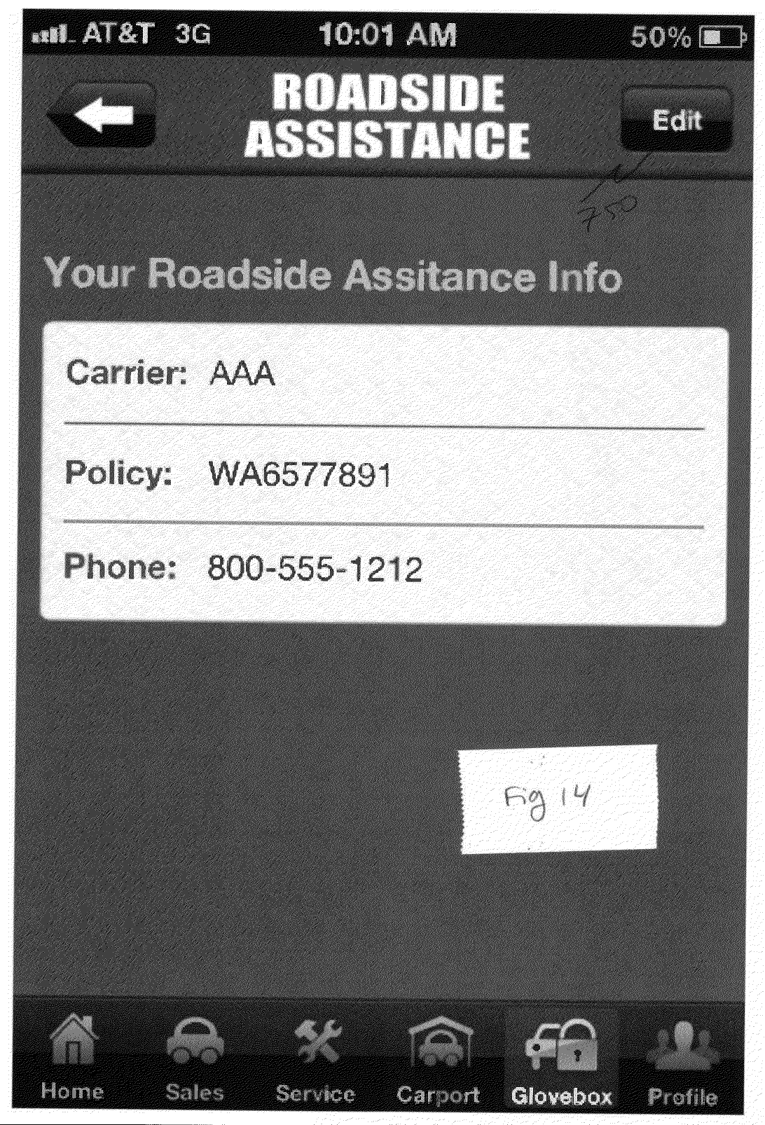

FIG. 14 illustrates a representative user interface screen where the user can enter, edit or recall information for roadside assistance. In the embodiment shown, the information is received and stored for a single provider of roadside assistance. However, if a vehicle is under warranty, the user may store information for two or more roadside assistance providers. A control 750 is provided on the user interface screen so a user can edit information associated with roadside assistance providers if desired.

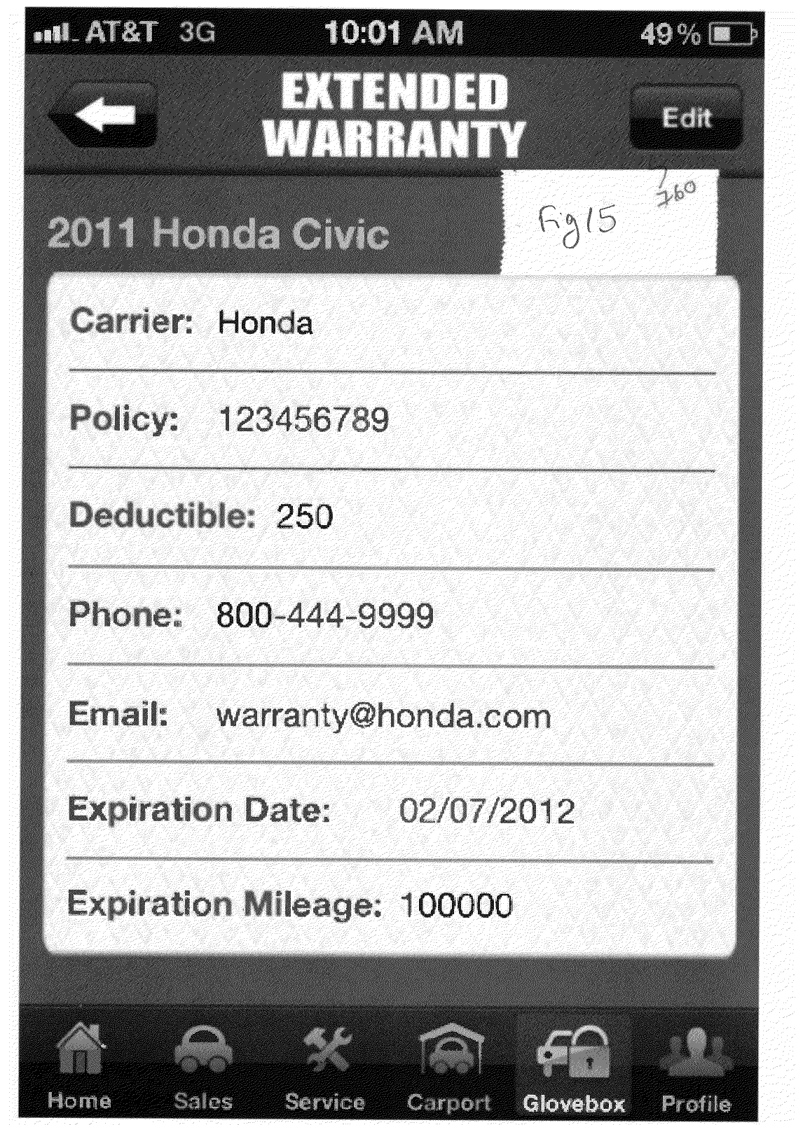

FIG. 15 illustrates a representative user interface screen whereby a user can enter, edit or recall information for an extended warranty purchased for a particular vehicle. In the user interface screen, the information is shown regarding a particular make and model of vehicle owned by the registered user for which an extended warranty has been purchased. The information displayed may include the carrier for the extended warranty policy, the policy number, the current deductible, a telephone number associated with the warranty, e-mail address for which the user can receive information associated with the extended warranty as well as the date and/or mileage when the warranty expires. A control 760 is provided so that a user can edit the information associated with the extended warranty for any particular vehicle.

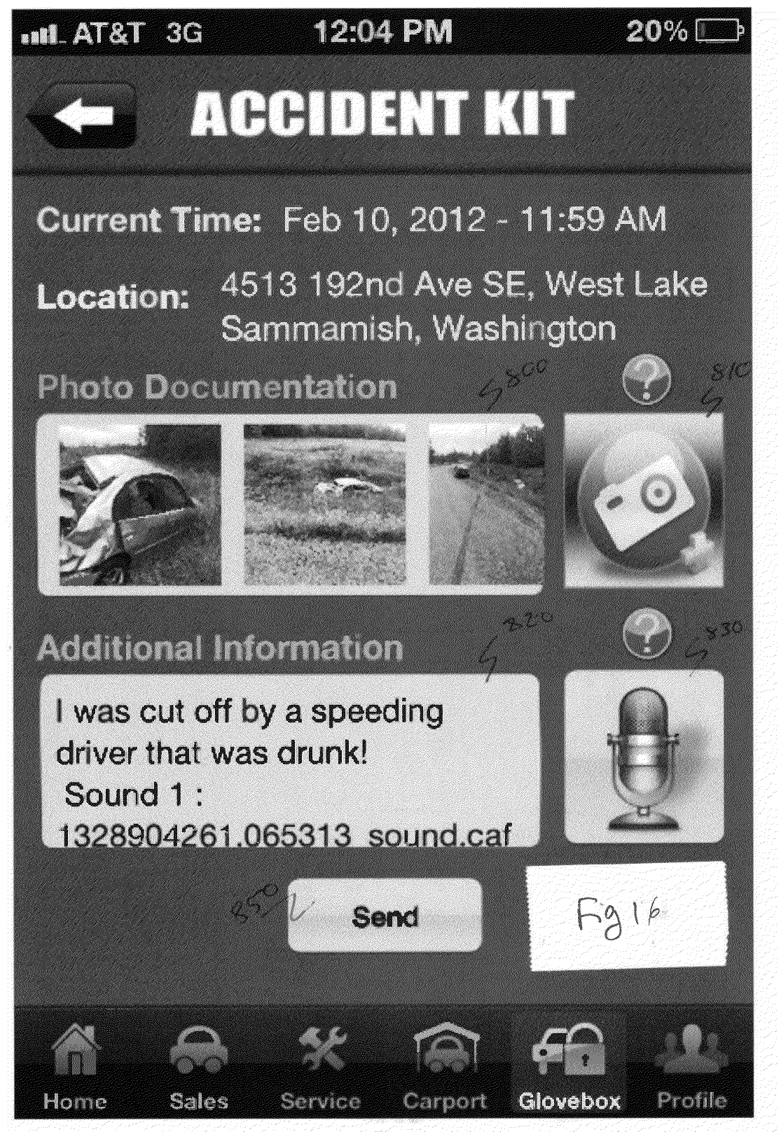

If in the event that a user is involved in an accident in one of their vehicles, the glove box portion of the mobile application includes an icon 705 that the user can select when they have an accident. Upon selection of the icon 705, the mobile application presents a user interface screen such as shown in FIG. 16. In one embodiment, the user interface screen shows the current date and time and information retrieved from a GPS or other location device associated with the mobile device upon which the app is running. A display 800 shows one or more images captured by the user of the accident screen and a control 810 allows the user to capture additional images if desired. Selection of the control 810 causes the mobile device to activate a camera on the mobile device so that the additional images can be recorded. A text window 820 is provided so that a user can enter textual information regarding the accident in question. A control 830 is provided so that a user can record audio information as a sound clip. If a sound clip is recorded, the file name for the sound clip is shown in the text window 820. A control 850 is provided that when selected by the user, causes the app to send all the information shown on the user interface screen regarding the accident to the e-mail or other contact address associated with the user's insurance carrier as well as a carbon copy to the user's own e-mail address.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include any number of clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

From the foregoing, it will be appreciated that specific embodiments of the invention have been described herein for purposes of illustration, but that various modifications may be made without deviating from the scope of the invention. For example, although the invention is described in terms of automobile sales and service, will be appreciated that the disclosed technology can be used with other types of vehicles including motorcycles, recreational vehicles (campers, motor homes, off road vehicles, snowmobiles etc.). The embodiments disclosed herein can be used in the automotive industry (e.g., by automotive manufactures, dealerships, service centers, etc.), insurance industry, or the like. In addition the technology can be adapted to other uses such as doctor, dentist practices or other environments where customer/patient contact is desired. Accordingly, the invention is not to be limited except as by the appended claims.

I/we claim:

1. A computer system, comprising:
a server computer including one or more processors that are configured to:
store a contact address and a vehicle identifier for a number of users;
receive service information indicative of suggested service procedures to be performed at different mileage intervals for a number of vehicle types;
determine if a vehicle identifier stored for a user is due for a suggested service and if so, to send a message to the contact address of the user associated with the vehicle;
receive a request for a service appointment from the user and an identifier that identifies a dealer who the user would like to perform the service; and
forward the service request to the identified dealer.

2. The server computer of claim 1, wherein the vehicle is one of an automobile, a boat, a recreational vehicle or a motor home.

3. The computer system of claim 1, wherein the server computer is configured to store an image a contact person at a dealer that is associated with the user and to transmit the image to the user with messages sent to the user.

4. A mobile computing device, comprising:
a memory for storing program instructions;
a processor configured to execute the program instructions to:
present a single user interface screen on the mobile device when a user has been involved in an accident, wherein the user interface screen includes a number of controls that can be selected to;
collect one or more photographs that a user captures of the accident;
capture a description of the accident;
recall a contact address for an insurance carrier of the user; and
transmit a message to the insurance carrier at the contact address that includes the name of the user, a date, time and location of the accident, the one or more photographs of the accident and the description of the accident.

5. The mobile computing device of claim 4, wherein the memory stores a digital certificate of proof of insurance and the processor is configured to display the proof of insurance on the user interface screen.

6. A mobile computing device, comprising:
a memory for storing program instructions;
a processor configured to execute the program instructions to:
present one or more user interface screens in which can enter:
a user identifier;
a VIN number of a vehicle; and
an identifier that represents a dealer;
transmit a message to a remote server computer that forwards the entered information; and
receive messages from the identified dealer regarding servicing the vehicle represented by the VIN number.

7. The mobile computing device of claim 6, wherein the processor is configured to execute instructions that transmit a request to schedule a service for the vehicle.

8. The mobile computing device of claim 6, wherein the processor is configured to execute instructions to receive and display promotional materials from the identified dealer.

9. The mobile computing device of claim 6, wherein the processor is configured to display a certificate of insurance for the vehicle.

10. The mobile computing device of claim 6, wherein the processor is configured to execute instructions to:
collect one or more photographs that a user captures of the accident;
capture a description of the accident;
recall a contact address for an insurance carrier of the user; and
transmit a message to the insurance carrier at the contact address that includes the name of the user, a date, time and location of the accident, the one or more photographs of the accident and the description of the accident.
